(19) United States
(12) Patent Application Publication
(10) Pub. No.: US 2022/0215229 A1
(43) Pub. Date: Jul. 7, 2022

(54) NEURAL NETWORK DEVICE AND LEARNING METHOD

(71) Applicant: KABUSHIKI KAISHA TOSHIBA, Tokyo (JP)

(72) Inventors: Yoshifumi NISHI, Yokohama Kanagawa (JP); Kumiko NOMURA, Shinagawa Tokyo (JP); Takao MARUKAME, Chuo Tokyo (JP); Koichi MIZUSHIMA, Kamakura Kanagawa (JP)

(73) Assignee: KABUSHIKI KAISHA TOSHIBA, Tokyo (JP)

(21) Appl. No.: 17/461,808

(22) Filed: Aug. 30, 2021

(30) Foreign Application Priority Data
Jan. 7, 2021 (JP) 2021-001704

(51) Int. Cl. G06N 3/04

(52) U.S. Cl. CPC G06N 3/049

(57) ABSTRACT

According to one embodiment, there is provided a neural network device including a neuron, a conversion part, a transmission part, a control part and a holding part. The conversion part converts a spike signal to a synapse current according to weight. The transmission part transmits the converted synapse current to the neuron. The control part determines transition of a state of the weight. The holding part holds the weight as a discrete state according to the determined transition of the state. The holding part includes an action part that stochastically operates based on a signal input from the control part to cause transition of the state of the weight. A cumulative probability of actions of the action part changes in a sigmoidal shape with respect to number of signal input times.

### CROSS-REFERENCE TO RELATED APPLICATIONS

This application is based upon and claims the benefit of priority from Japanese Patent Application No. 2021-001704, filed on Jan. 7, 2021; the entire contents of which are incorporated herein by reference.

### FIELD

Embodiments described herein relate generally to a neural network device and a learning method.

### BACKGROUND

In a neural network device using the theory of the spike timing dependent plasticity (STDP), synaptic weight is generally expressed with continuous values, and changes by an amount determined by STDP in learning.

### BRIEF DESCRIPTION OF THE DRAWINGS

FIG. 1 is a chart illustrating stochastic spike timing dependent plasticity (STDP);

FIG. 2 is a diagram illustrating learning performed by a neural network device;

FIG. 3 is a chart illustrating a relation between the number of additional learning times and the forgetting number after learning;

FIG. 4 is a chart illustrating simplified stochastic STDP;

FIG. 5A is a chart illustrating a cumulative probability distribution of an exponential-function behavior;

FIG. 5B is a chart illustrating a cumulative probability distribution of a sigmoidal function behavior;

FIG. 5C is a chart illustrating a cumulative probability distribution of a sigmoidal function behavior;

FIG. 5D is a chart illustrating a cumulative probability distribution of a sigmoidal function behavior;

FIG. 6 is a block diagram illustrating a neural network device according to a first embodiment;

FIG. 7 is a chart illustrating a characteristic of a switching element;

FIG. 8 is a chart illustrating a characteristic of a element;

FIG. 9A is a diagram illustrating an action of a stochastic action part; of the

FIG. 9B is a diagram illustrating an action of the stochastic action part; of the

FIG. 9C is a diagram illustrating an action stochastic action part;

FIG. 9D is a diagram illustrating an action stochastic action part;

FIG. 10 is a chart illustrating a cumulative probability distribution of a gamma distribution behavior;

FIG. 11 is a chart illustrating a relation between the number of additional learning times and the forgetting number;

FIG. 12 is a circuit diagram of the neural network device;

FIG. 13 is a diagram illustrating inference performed by the neural network device;

FIG. 14 is a diagram illustrating inference performed by the neural network device;

FIG. 15A is a diagram illustrating learning performed by the neural network device;

FIG. 15B is a diagram illustrating learning performed by the neural network device;

FIG. 15C is a diagram illustrating learning performed by the neural network device;

FIG. 15D is a diagram illustrating inference performed by the neural network device;

FIG. 16 is a circuit diagram of a neural network device according to a second embodiment;

FIG. 17 is a chart illustrating a cumulative probability distribution of a Weibull distribution behavior;

FIG. 18 is a circuit diagram of a neural network device according to a third embodiment;

FIG. 19A is a diagram illustrating inference performed by the neural network device;

FIG. 19B is a diagram illustrating inference performed by the neural network device;

FIG. 20A is a diagram illustrating learning performed by the neural network device;

FIG. 20B is a diagram illustrating learning performed by the neural network device;

FIG. 20C is a diagram illustrating learning performed by the neural network device;

FIG. 20D is a diagram illustrating inference performed by the neural network device; and

FIG. 21 is a chart illustrating a relation between the number of additional learning times and the forgetting number.

### DETAILED DESCRIPTION

In general, according to one embodiment, there is provided a neural network device including a neuron, a conversion part, a transmission part, a control part and a holding part. The conversion part converts a spike signal to a synapse current according to weight. The transmission part transmits the converted synapse current to the neuron. The control part determines transition of a state of the weight. The holding part holds the weight as a discrete state according to the determined transition of the state. The holding part includes an action part that stochastically operates based on a signal input from the control part to cause transition of the state of the weight. A cumulative probability of actions of the action part changes in a sigmoidal shape with respect to number of signal input times.

Embodiments of a neural network device according to the present invention will be described hereinafter in detail with reference to the accompanying drawings. The present invention is not limited to the following embodiments.

The neural network device according to the embodiments is aimed at brain-inspired hardware on which artificial intelligence is loaded.

Recently, the artificial intelligence technology has been rapidly developing in association with the progress in computer hardware represented by Graphical Processing Unit (GPU). For example, the image recognition/classification technology represented by Convolutional Neural Network (CNN) has already been used in various scenes in the real world. The widely used artificial intelligence technology nowadays is based on a simplified mathematical model of the behavior of a biological neural network, and it is suited for being executed by a computer such as a GPU. Note, however, that a large amount of electricity is required for executing the artificial intelligence with a GPU. Especially, massive computation is required for a learning action for extracting and storing features from a vast amount of data and an extremely large amount of electricity is required for that, so that it is concerned that the learning action on edges may become difficult.

On the contrary, a human brain is capable of learning a vast amount of data online at all times even though the consumption energy thereof is as low as about 20 W. Therefore, technologies for performing information processing by relatively faithfully duplicating the behavior of the brain with an electric circuit are being studied in countries all over the world.

In a brain neural network, information is transmitted from a neuron (nerve cell) to another neuron as a signal by a voltage spike. A neuron and another neuron are connected by a junction called a synapse. When a certain neuron fires and causes a voltage spike, the voltage spike is input to a post-neuron via the synapse. At this time, intensity of the voltage spike input to the post-neuron is adjusted by the connection strength (referred to as “weight” hereinafter) of the synapse. When the weight is large, the voltage spike is transmitted to the post-neuron while keeping the high intensity. However, when the weight is small, the intensity of the voltage spike to be transmitted is low. Therefore, the larger the weight of the synapse between the neurons, the stronger the informational relation between the neurons.

The weight of the synapse is known to change depending on the firing timing of the neuron. That is, assuming that a voltage spike is input from a certain neuron (pre-neuron) to a next neuron (post-neuron), if the post-neuron fires at this time, it is considered that there is a causal relation between the information held by those two neurons so that the weight of the synapse between those two neurons becomes large. Inversely, if the voltage spike from the pre-neuron arrives after the post-neuron fires, it is considered that there is no causal relation between the information held by those two neurons so that the weight of the synapse between those two neurons becomes small. Such a characteristic that the weight of the synapse changes depending on the timing of the voltage spike is referred to as spike timing dependent plasticity (STDP).

The technology that expresses and processes the flow of information as a spike train within an electric circuit by imitating such an information processing theory of the neural network is called a spiking neural network. With the spiking neural network, all information processing is performed by accumulation, generation, and transmission of voltage spikes without doing numeric calculations. While massive computation is required for learning with the conventional artificial intelligence, it is considered that data learning can be efficiently performed with the spiking neural network by using the theory of STDP, so that studies thereof are being conducted actively.

The synaptic weight is generally expressed with continuous values, and changes by an amount determined by STDP in learning. Thus, when the spiking neural network is configured with hardware, a memory for expressing the continuous values is required. Currently, the widely used memory stores information with a digital mode. However, since many bits are required for storing the continuous values with the digital mode, a large memory is required for that. There are also memories that store analog values, such as a resistance change memory and a phase change memory. However, precise signal control is required for accurately writing target values to the analog memory, so that the circuit and system for the control may be complicated and the size thereof may become huge.

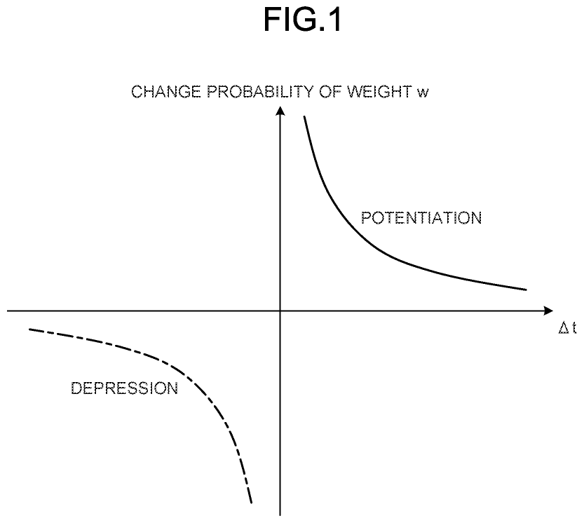

In order to avoid such an issue, it is desirable to use discrete values for the synaptic weight. The simplest discrete synaptic weight is binary synaptic weight. That is, it is the synapse allowed to use only “0” and “1” as the weight values. When the binary synaptic weight is employed, the weight change amount is only “1”. Therefore, information of the causal relation of the spike timing cannot be expressed well with STDP, and learning cannot be done well if the binary synaptic weight is applied as it is. Therefore, learning can be performed by using stochastic STDP that determines “weight change probability” and changes the weight value from “0” to “1” or from “1” to “0” according to the probability instead of determining “weight change amount” by STDP (FIG. 1).

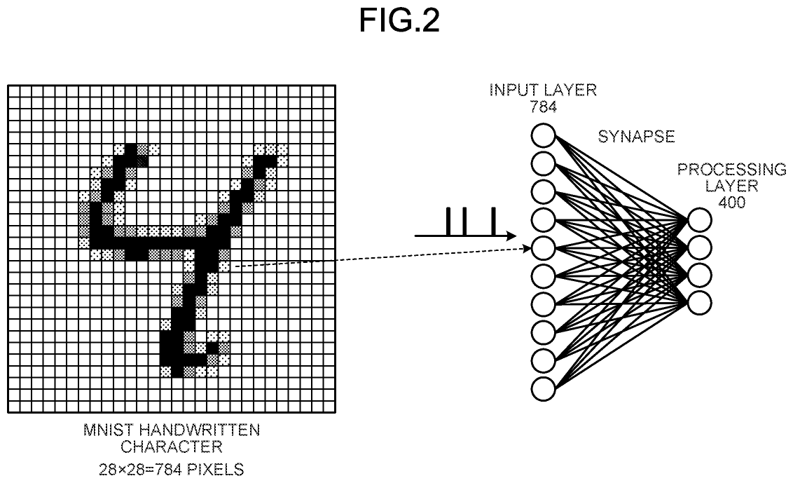

However, there are following issues with the stochastic STDP. As an example, it is assumed that a spiking neural network is used to learn image data of 28×28=784 pixels as in FIG. 2. Here, contrast is input to 784 neurons of an input layer from each pixel. The neurons of the input layer generate a spike train of the spike density according to the contrast, and transmit voltage spikes to 400 neurons on a processing layer of a latter stage. The neurons of the input layer and the neurons of the processing layer are connected via synapses. In the synapse, the synaptic weight is changed by STDP according to the input spike and firing timing of the neuron. There is an interaction working between the neurons for inhibiting with each other so that a plurality of neurons do not fire simultaneously.

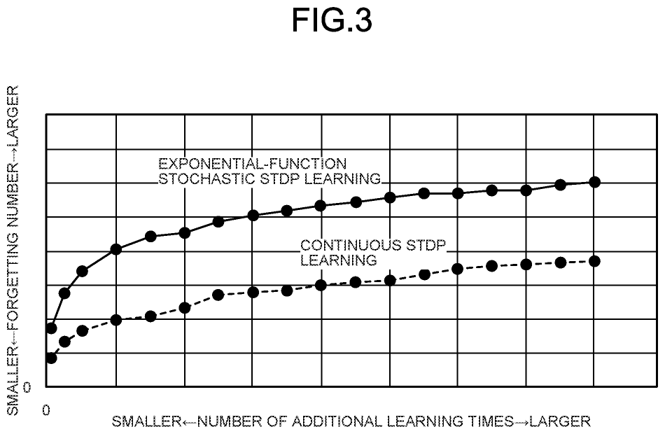

FIG. 3 is a comparison regarding the memory retaining properties of the general STDP using continuous weight (referred to as continuous STDP hereinafter) and the stochastic STDP. That is, it illustrates the number of neurons that lost the pattern stored at the point of 10000 times with respect to the number of additional learning times, in a case where the additional learning is performed further after learning 10000 patterns of MOIST handwritten characters. As can be seen from FIG. 3, it is found that the number of neurons that lost the stored pattern is greater in the stochastic STDP than in the continuous STDP, and that the memory retaining property thereof is deteriorated. It is desirable that learning by STDP is used not for batch learning that learns vast amount of data all at once but for what is called the online learning that repeats learning every time data is input. However, when the memory retaining property is poor, the memory is easily overwritten by new data so that what is learned in the past may be easily forgotten.

The STDP learning by binary synapses can be implemented by reading the update width with the transition probability. However, with the stochastic STDP, the stored pattern of the neuron is easily overwritten with a new learning pattern when additional learning is performed, thereby deteriorating the memory retaining property. Herein, provided is binary synaptic brain hardware capable of performing the stochastic STDP learning while keeping the past stored patterns.

As mentioned above, when performing learning by using the stochastic STDP in a neural network with the binary synaptic weight, the memory retaining property of the learned content may be deteriorated.

### First Embodiment

Thus, in the first embodiment, the neural network with the binary synaptic weight uses a stochastic action part in which the cumulative probability of synaptic transition exhibits a sigmoidal function behavior in order to improve the memory retaining property of the content learned by the stochastic STDP learning.

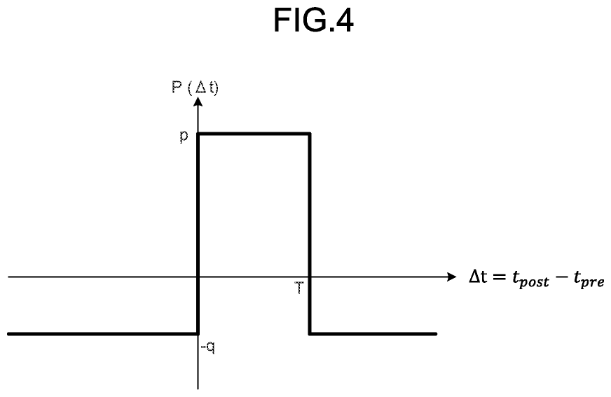

First, changes in the binary weight by the stochastic STDP will be discussed herein in detail. It is to be noted that weight w of the synapse takes a value of “0” or “1”. In order to simplify the discussion hereinafter, simplified stochastic STDP as illustrated in FIG. 4 will be used. That is, regarding time difference Δt=tₚᵣₑ−tₚₒₛₜ between time tₚᵣₑ at which a spike is input to a synapse and time tₚₒₛₜ at which a connected neuron fires, it is assumed that the synapse with the weight w=0 when 0<Δt<T transitions to w=1 with probability p, and the synapse with the weight w=1 transitions to w=0 with probability q in other cases. Hereinafter an action for causing transition from w=0 to 1 (even if there is no actual transition) is called potentiation, and an action for causing transition from w=1 to 0 (even if there is no actual transition) is called depression.

If a potentiation action continuously occurs N-times when the synaptic weight is w=0, the probability that the synapse state actually transitions to w=1 is expressed as follows.

P(w=1)=1−(1−p)^{N} . . . Formula 1

Therefore, the expected value of w after the potentiation action continuously occurred N-times when the synaptic weight is w=0 is as follows.

<w>=1−(1−p)^{N} . . . Formula 2

Similarly, assuming that a depression action occurs N-times when the synaptic weight is w=1, the probability that the synapse actually transitions to w=0 is expressed as follows.

P(w=0)=1−(1−q)N . . . Formula 3

Therefore, the expected value of w after the depression action continuously occurred N-times when the synaptic weight is w=1 is as follows.

<w>=(1−q)N . . . Formula 4

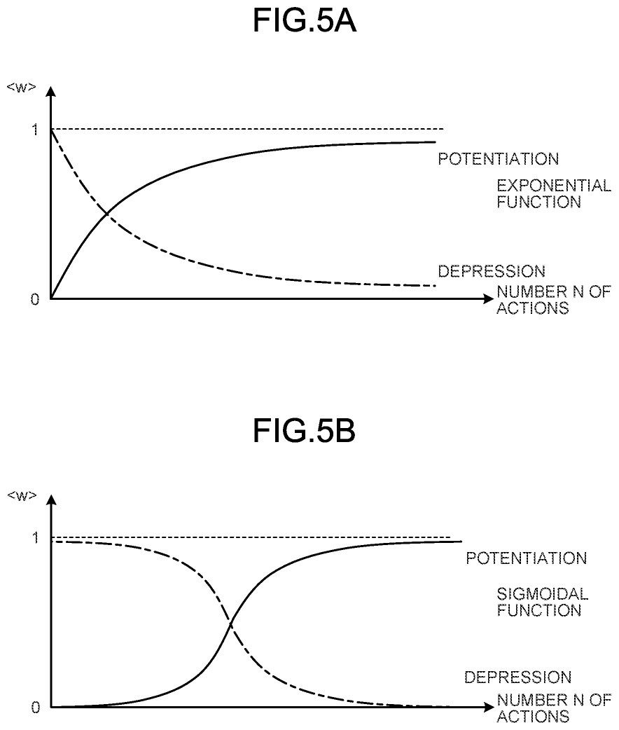

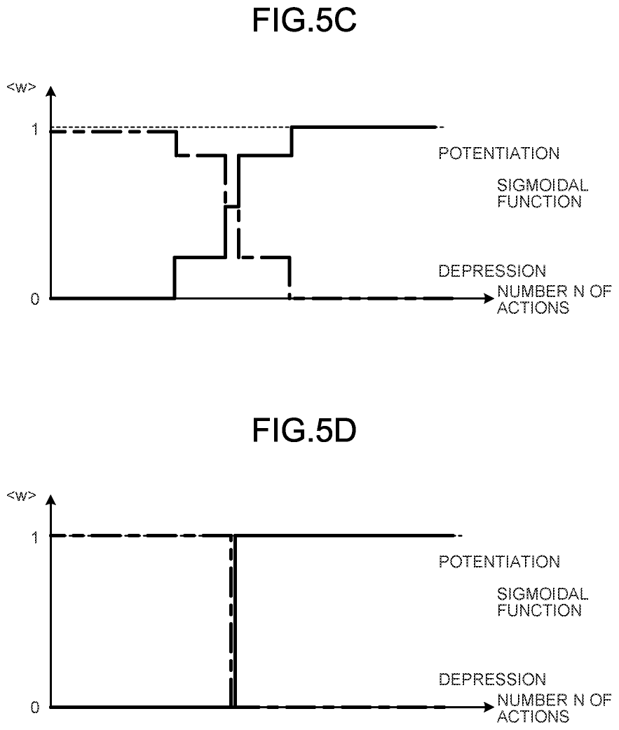

With the stochastic STDP, the probability source may exhibit an exponential-function characteristic. With the stochastic STDP, the expected value of Formula 2 for the potentiation action may be expressed on a graph as a distribution indicated by a solid line in FIG. 5A, and the expected value of Formula 4 for the depression action may be expressed on a graph as a distribution indicated by an alternate long and short dash line in FIG. 5A. There are exponential changes observed in both cases, so that the weight expected value <w> greatly changes when the number N of the potentiating or depression actions is small and it is saturated as N becomes greater. That is, statistically, it is found that the actions of first several times have a greater influence on the change of the synapse state. From the viewpoint of the memory retaining property, it can be considered that the actions of the first several times destroy the already formed memory of the synapse and overwrite it with a new memory. With learning by the exponential-function stochastic STDP, transition of the weight occurs mostly in the initial stage and the existing memory tends to disappear easily.

For that, as will be described hereinafter, it is possible to suppress the influence on the expected values imposed by the initial stage of the potentiation/depression actions by using the probability source where the weight expected value <w> has a sigmoidal function characteristic for the number N of actions to be performed.

The probability source is configured such that the cumulative probability for potentiation/depression actions changes in an sigmoidal shape with respect to the number N of actions. To change in a sigmoidal shape means a change as follows. For example, it is a change where the expected value gradually rises while the number N of actions is small, then the expected value starts to increase drastically as the number N of actions increases, and thereafter the increase of the expected value becomes gradual again. Alternatively, it is a change where a linear function of the expected value forms a concave upward as the number N of actions increases, for example. That is, the cumulative probability distribution of the actions of the probability source is formed to fit a sigmoidal function to moderate the rise of the transition of the weight so as to protect the existing memory. For example, the expected value of the probability source for the potentiation action may change curvaceously along a sigmoidal shape with respect to the number N of actions as indicated by a solid line in FIG. 5B, and the expected value of the probability source for the depression action may change curvaceously along an inverted sigmoidal shape with respect to the number N of actions as indicated by an alternate long and short dash line in FIG. 5B. Alternatively, the expected value of the probability source for the potentiation action may change polylinearly in a multistep manner along an sigmoidal shape with respect to the number N of actions as indicated by a solid line in FIG. 5C, and the expected value of the probability source for the depression action may change polylinearly in a multistep manner along an inverted sigmoidal shape with respect to the number N of actions as indicated by an alternate long and short dash line in FIG. 5C. Alternatively, the expected value of the probability source for the potentiation action may change polylinearly in a singlestep manner along an sigmoidal shape with respect to the number N of actions as indicated by a solid line in FIG. 5D, and the expected value of the probability source for the depression action may change polylinearly in a singlestep manner along an inverted sigmoidal shape with respect to the number N of actions as indicated by an alternate long and short dash line in FIG. 5D. Hereinafter the case where the probability source exhibits the cumulative probability distribution presented in FIG. 5B will be mainly described as an example. However, the idea of the embodiments may also be applied to the cases where the probability source exhibits the cumulative probability distribution presented in FIG. 5C or FIG. 5D.

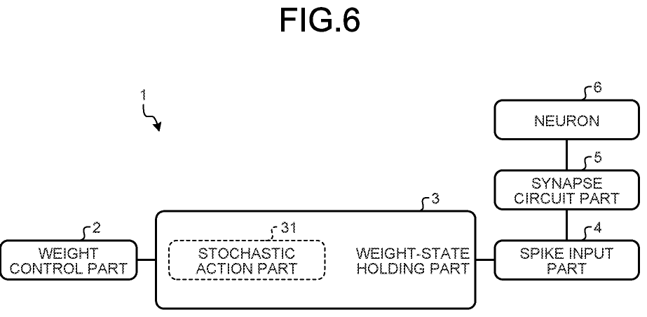

A neural network device 1 may be configured as illustrated in FIG. 6. The neural network device 1 includes a neuron 6, a spike input part 4, a synapse circuit part 5, a weight-state holding part 3, and a weight control part 2. While a single neuron and a single synapse circuit are illustrated in FIG. 6 for simplifying the drawing, the neural network device 1 includes a plurality of neurons and a plurality of synapses (see FIG. 2).

The spike input part 4 converts a spike signal to a synapse current according to the weight. The synapse circuit part 5 transmits the synapse current to a neuron. The weight-state holding part 3 maintains the synaptic weight as a discrete state. The weight control part 2 determines transition of the weight state. The weight-state holding part 3 includes a stochastic action part 31. The stochastic action part 31 stochastically operates according to the signal input from the weight control part 2 to cause transition of the weight state. The stochastic action part 31 is configured such that the cumulative action probability for the number of signal input times forms a sigmoidal function when a same signal is repeatedly input to the stochastic action part 31.

When updating the weight by STDP, for example, the weight control part 2 monitors the timings of the input spike and firing of the neuron, and sends a signal for updating the weight state to the stochastic action part 31 according to a difference of the timings. As mentioned above, the stochastic action part 31 is designed such that the cumulative action probability for the number of signal input times forms a sigmoidal function when a same signal is repeatedly received from the weight control part 2. Hereinafter an example of a method will be described for implementing a probability distribution where the cumulative probability for the number of trials forms a sigmoidal function. Consider a switch that transitions from an OFF-state to an ON-state with probability p for one action. The probability that the switch is in an ON-state after operating N-times the switch in an OFF-state can be given as follows.

1−(1−p)^{N}=1−exp(−λN) . . . Formula 5

It is to be noted that λ=−1n(1−p). As a switching element that stochastically transitions from an OFF-state to an ON-state, it is possible to use a resistance change element, for example.

The resistance change element is a two-terminal element in which a thin film of a metal oxide or an ion conductor is sandwiched between an upper electrode and a lower electrode. In the resistance change element, when a voltage is applied to the upper and lower electrodes, oxygen vacancies or ions inside thereof move and a conductive path is generated and destructed therein, thereby changing the resistance. Examples of the metal oxide may be a tantalum oxide, a titanium oxide, a hafnium oxide, a tungsten oxide, a magnesium oxide, and an aluminum oxide. Examples of the ion conductor may be a germanium sulfide, a germanium selenide, a silver sulfide, and a copper sulfide. It is assumed herein that the resistance change element is formed with a metal oxide and that the resistance changes according to the oxygen vacancies inside.

Hereinafter it is assumed that the resistance change element takes two states that are a high resistance state (High-level Resistance State: HRS) and a low resistance state (Low-level Resistance State: LRS). HRS is a state where the conductive path is destructed, and LRS is a state where the conductive path is formed. When a voltage is applied to the resistance change element under HRS, the oxygen vacancies inside thereof migrate by an electric field and forms a conductive path, so that HRS transitions to LRS as described above. This is called SET. A SET action is a transition from HRS to LRS, which corresponds to an ON-action of the switching element.

It should be noted that, when the resistance change element is a bipolar type, in a RESET action, a voltage is applied to the resistance change element with an inverted polarity from that of a SET action to flow a current in an inverted direction from that of the SET action, so that the resistance change element transitions from LRS to HRS. The RESET action corresponds to an OFF-action of the switching element.

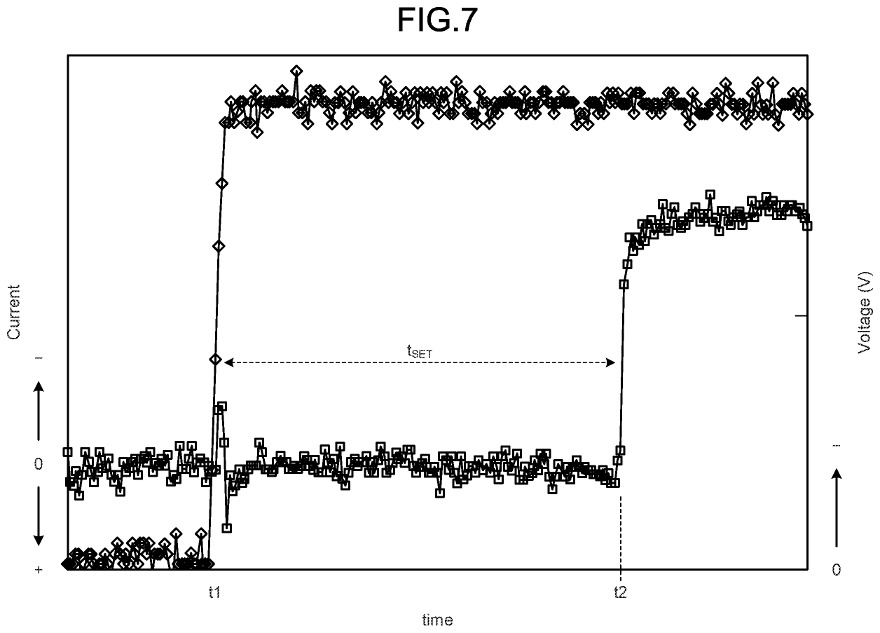

FIG. 7 illustrates changes in the current when a voltage is applied to the HRS state of the resistance change element formed by a tantalum oxide (TaOₓ) film. In FIG. 7, the vertical axis indicates current/voltage values assuming that the time of the SET action is positive and the horizontal axis indicates the time.

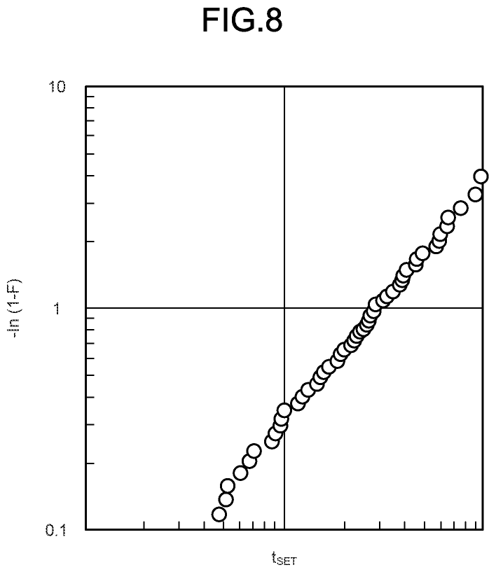

It may be seen that almost no current flows at a time point t1 where a voltage is applied and that the element is under HRS. It may be seen that when time t_{SET} passes from the point where the voltage is applied, SET occurs at a time point t2, the current increases drastically, and the element transitions to LRS. The time from the time point t1 to the time point t2 is t_{SET}. The time t_{SET} from the time point where the voltage is applied to the time point where SET occurs is not constant but varies greatly for each trial. This is considered that it is because formation of the conductive path greatly depends on the distribution state of the oxygen vacancies inside. FIG. 8 illustrates a t_{SET} distribution when t_{SET} is measured repeatedly with the same resistance change element formed with a TaOₓ thin film. In FIG. 8, the vertical axis indicates −1n(1−F) with logarithm, and the horizontal axis indicates t_{SET} with logarithm. Note that F is a cumulative frequency, and t_{SET} is the time from the time point where the voltage is applied to the time point where SET occurs as illustrated in FIG. 7. As may be seen from FIG. 8 that there is a following relation between −1n(1−F) and t_{SET}, since it forms a line with a gradient of 1 in a double logarithmic plot of those.

$$F = 1 - exp ( - \frac{{t}_{SET}}{T} ) \qquad Formula 6$$

Note here that T is a constant. Therefore, considering that SET is performed with a voltage pulse of a duration tₚᵤₗₛₑ, SET probability p thereof can be given as follows.

$$p = 1 - exp ( - \frac{{t}_{pulse}}{T} ) \qquad Formula 7$$

To apply a pulse voltage N-times exactly means to apply a voltage of a duration Ntₚᵤₗₛₑ. Therefore, the SET probability after applying the voltage pulse N-times is expressed as follows.

$$1 - exp ( - \frac{N {t}_{pulse}}{T} ) = 1 - {( 1 - p )}^{N} \qquad Formula 8$$

This is almost the same as Formula 5. That is, assuming that HRS is an OFF-state and LRS as an ON-state, the resistance change element can be considered as a stochastic switching element that stochastically changes from an OFF-state to an ON-state by applying the voltage pulse.

A series-connected switch in which k— pieces of such stochastic switching elements are connected will be discussed. That is, there are k-pieces of switching elements in total, and it is assumed that the i-th switching element stochastically operates when the (i−1)-th switching element is in an ON-state. Note, however, that the first switching element stochastically operates unconditionally. It is assumed that all of k-pieces of switching elements are in an OFF-state initially. An action for causing the switching elements to transition to an ON-state is performed in one trial.

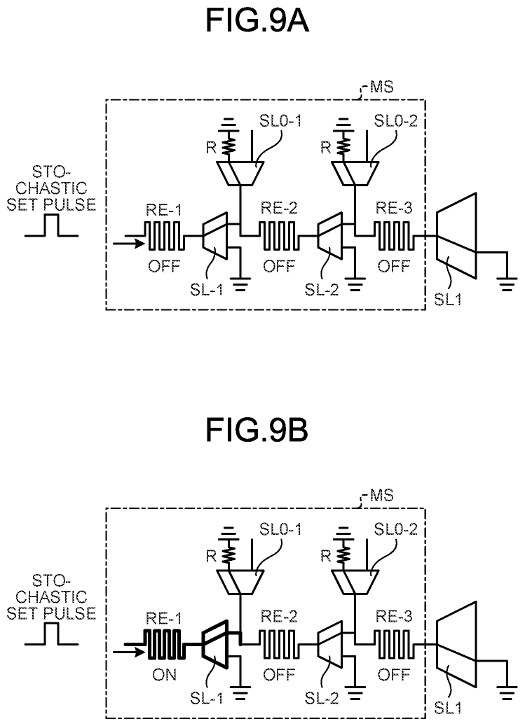

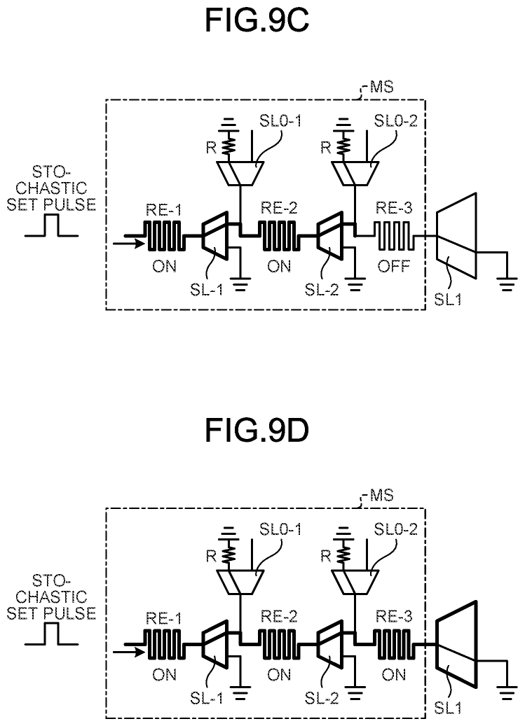

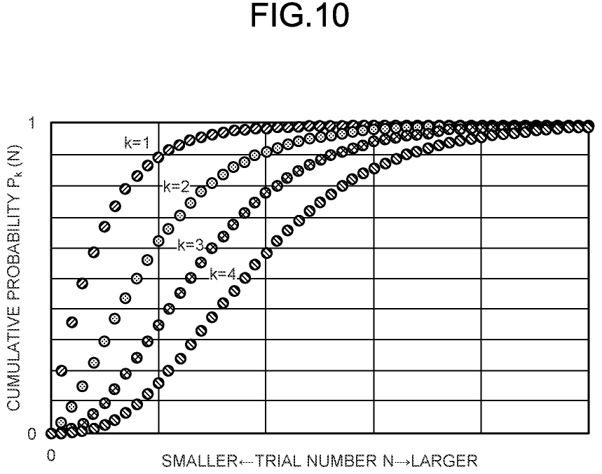

Such a series-connected switch MS may be configured as in FIG. 9A to FIG. 9D by using a plurality of resistance change elements RE-1 to RE-3. FIG. 9A to FIG. 9D illustrate a configuration corresponding to k=3 as an example.

The series-connected switch MS includes the resistance change elements RE-1 to RE-3, a plurality of selectors SL-1, SL-2, a plurality of selectors SL0-1, SL0-2, and a plurality of resistance elements R. A selector SL1 is connected to an output node of the series-connected switch MS.

The resistance change element RE-1 receives a signal input from the weight control part 2 at its one end, and the other end thereof is connected to the selector SL-1. As for the selector SL-1, an input node is connected to the resistance change element RE-1, a first output node is connected to the resistance change element RE-2 and the selector SL0-1, and a second output node is connected to a ground potential. As for the selector SL0-1, an input node is connected to the selector SL-1 and the resistance change element RE-2, a first output node is connected to a ground potential via the resistance element R, and the other end is connected to a prescribed power supply potential. The resistance change element RE-2 has its one end connected to the selector SL-1, and the other end connected to the selector SL-2. As for the selector SL-2, an input node is connected to the resistance change element RE-2, a first output node is connected to the resistance change element RE-3 and the selector SL0-2, and a second output node is connected to a ground potential. As for the selector SL0-2, an input node is connected to the selector SL-2 and the resistance change element RE-3, a first output node is connected to a ground potential via the resistance element R, and a second output node is connected to a prescribed power supply potential. The resistance change element RE-3 has its one end connected to the selector SL-2, and the other end connected to the selector SL1. As for the selector SL1, an input node is connected to the resistance change element RE-3, a first output node is connected to a latter stage, and a second output node is connected to a ground potential.

At the time of learning, each of the selectors SL-1 and SL-2 selects the first output node, the selector SL1 selects the second output node, and each of the selectors SL0-1 and SL0-2 selects the first output node.

For each of the resistance change elements RE, the resistance value under an OFF-state (HRS) is defined as R_{OFF} and the resistance value under an ON-state (LRS) is defined as R_{ON}. It is assumed that the node between the resistance change element RE and the resistance change element RE is grounded via the selector SL0 and the resistance element R. Note here that Formula as follows is satisfied provided that the resistance value of the resistance element R is R.

R_{OFF}»R»R_{ON} . . . Formula 9

First, it is assumed that all of the resistance change elements RE-1 to RE-3 are in an OFF-state, and a stochastic SET pulse is applied from the weight control part 2 to one end of the resistance change element RE-1. Since the other end of the resistance change element RE-1 is grounded via the selectors SL-1, SL0-1 and the resistance R, a voltage is applied to the resistance change element RE-1 by the pulse with the condition of Formula 9. When it is continued to apply the SET pulse intermittently, the resistance change element RE-1 stochastically transitions to an ON-state according to Formula 8.

As illustrated in FIG. 9B, when the resistance change element RE-1 turns to an ON-state, the SET pulse passes through the resistance change element RE-1 and reaches the resistance change element RE-2, and the voltage by the pulse is applied to the resistance change element RE-2 with the condition of Formula 9. When the stochastic SET pulse is continued to be applied thereto intermittently as the voltage pulse, the resistance change element RE-2 stochastically transitions to an ON-state this time according to Formula 8.

As illustrated in FIG. 9C, when the resistance change element RE-2 turns to an ON-state, the SET pulse passes through the resistance change element RE-1 and the resistance change element RE-2, and the voltage is applied to the resistance change element RE-3 also with the condition of Formula 9. When the SET pulse is continued to be applied thereto intermittently, the resistance change element RE-3 stochastically transitions to an ON-state also according to Formula 8. Thereby, as illustrated in FIG. 9D, the entire series-connected switch MS turns to an ON-state.

It should be noted that, when the SET pulse is applied to the series-connected switch MS that is entirely in an OFF-state so that the resistance RE-1 transitions to ON-state, the SET pulse is also applied to the resistance change element RE-2. Therefore, it is possible that the resistance change element RE-1 and the resistance change element RE-2 may both transition to an ON-state by applying the SET pulse once. Similarly, it is also possible that all of the resistance change elements RE-1 to RE-3 may transition to an ON-state by applying the SET pulse once

Provided that “N” in Formula 5 is a random variable, this Formula is a cumulative probability distribution function of an exponential distribution. When the switching element that is in an OFF-state after trials of (N−1) times actually transitions to an ON-state in the N-th trial, the probability is given by p(1−p)^{N-1}. Since λ=−1n(1−p)≅p under a condition of p»1, it is expressed as follows.

p(1−p)N−1≅λ exp[−λ(N−1)] . . . Formula 10

Assuming that “N” is the continuous random variable, Formula 10 is exactly a probability density function of an exponential distribution. Now, it is assumed that the number of trials until the first switching element changes to ON is N₁, the number of trials until the second switching element changes to ON after the first switching element changed to ON is N₂, . . . , the number of trials until the i-th switching element changes to ON after the (i−1)-th switching element changed to ON is N₁, . . . (N₁=0 when the (i−1)-th and i-th switching elements are changed to ON simultaneously), and the sum total of all trials is N=N₁+N₂+ . . . +Nₖ. Since each N₁ can be considered as a random variable that follows the exponential distribution, N as the sum thereof is a gamma distribution following the random variables expressed as follows.

$${f}_{k} ( N ) = \frac{1}{Γ ( k )} {p}^{k} {N}^{k - 1} exp ( - pN ) \qquad Formula 11$$

Therefore, probability Pk(N) that the switching elements of k-pieces are all changed to ON after trials of N-times is expressed as follows.

$${P}_{k} ( N ) = {\sum }_{m = 1}^{N} {f}_{k} ( m ) = \frac{{p}^{k}}{Γ ( k )} {\sum }_{m = 1}^{N} {m}^{k - 1} exp ( - pm ) \qquad Formula 12$$

Formula 12 may be approximated as follows by using the first kind incomplete gamma function γ.

$${P}_{k} ( N ) ≅ {\int }_{0}^{N} {f}_{x} ( x ) dx = \frac{1}{Γ ( k )} {\int }_{0}^{N} {x}^{k - 1} {p}^{k} exp ( - px ) dx = \frac{γ ( k , pN )}{Γ ( k )} \qquad Formula 13$$

This is exactly a cumulative distribution function of a gamma distribution.

FIG. 10 is a graph of Pk(N) of a case where p=0.2, and k=2, 3, 4 in Formula 12. As “k” increases, the probability when the number N of trials is small is suppressed low, and it can be seen that a cumulative probability function of a sigmoidal function as in FIG. 5B can be implemented. That is, a sigmoidal function may be implemented by repeating stochastic actions in series, so that it is considered that a series-connected switch in which stochastic switching elements are connected in k-pieces exhibits a sigmoidal behavior.

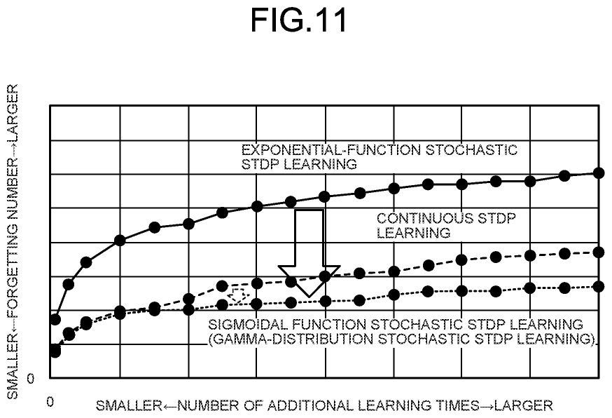

FIG. 9A illustrates a configuration using the series-connected switch MS in which switching elements of k=3 pieces are connected. After learning 10000 patterns of MNIST handwritten characters with the stochastic STDP by using the series-connected switch MS, additional learning was performed further. FIG. 11 illustrates, as a sigmoidal function stochastic STDP learning (gamma-distribution stochastic STDP learning), the number of neurons that lost the pattern stored at the point of 10000 times with respect to the number of additional learning times, plotted as forgetting numbers. The gamma-distribution stochastic STDP is an example of the sigmoidal function stochastic STDP.

With the sigmoidal function stochastic STDP according to the embodiment, for an arbitrary number of additional learning times, the forgetting number is greatly decreased with respect to the exponential-function stochastic STDP as indicated in FIG. 11 by a white arrow written with a solid line. In addition, as indicated in FIG. 11 by the white arrow written with a solid line, the sigmoidal function stochastic STDP according to the embodiment has an advantage with respect to the continuous STDP learning. With the sigmoidal function stochastic STDP learning according to the embodiment, the memory retaining property of the network may be improved compared to those of the exponential-function stochastic STDP learning and the continuous STDP learning.

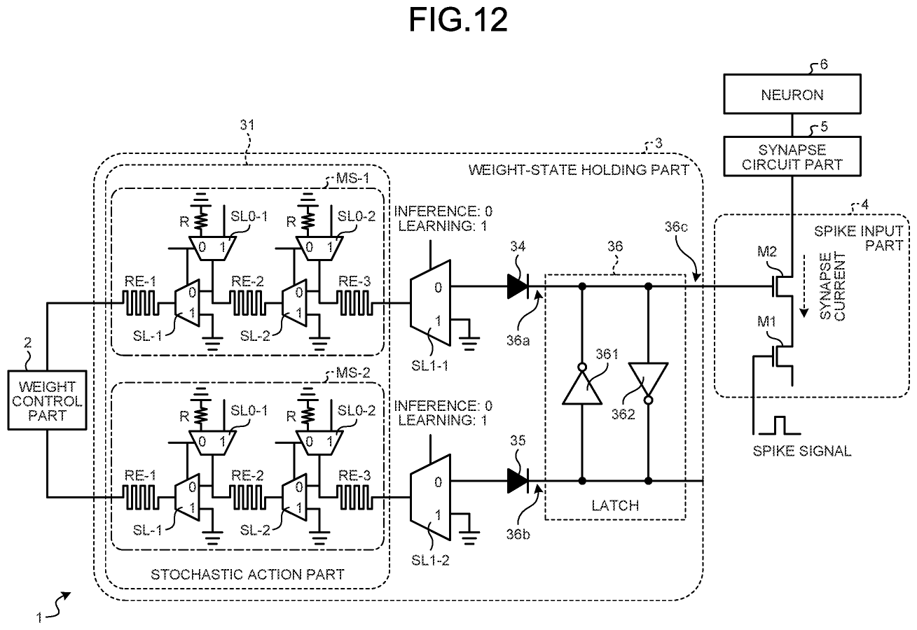

A specific circuit example of the neural network device 1 is illustrated in FIG. 12. The neural network device 1 is configured by using, as a stochastic synapse, the series-connected switch MS in which the resistance change elements RE illustrated in FIG. 9A to FIG. 9D are connected in series. While a single neuron and a single synapse circuit are illustrated in FIG. 12 for simplifying the drawing, the neural network device 1 includes a plurality of neurons and a plurality of synapses (see FIG. 2).

The neural network device 1 illustrated in FIG. 12 uses two sets of series-connected switches MS-1 and MS-2 on top and bottom, and each of those is connected to a latch 36 in the center. In the neural network device 1, the weight-state holding part 3 includes the stochastic action part 31, the selector SL1-1, the selector SL1-2, a rectifier element 34, a rectifier element 35, and the latch 36. The stochastic action part 31 includes a plurality of the series-connected switches MS-1 and MS-2. The series-connected switches MS-1 and MS-2 are arranged in parallel between the weight control part 2 and the latch 36. Between the weight control part 2 and the latch 36, a serial connection of the series-connected switch MS-1, the selector SL1-1, and the rectifier element 34 and a serial connection of the series-connected switch MS-2, the selector SL1-2, and the rectifier element 35 are connected in parallel. Each of the series-connected switches MS-1 and MS-2 is the same as the series-connected switch MS illustrated in FIG. 9A.

The spike input part 4 is provided with a transistor M1 capable of allowing a synapse current to flow by receiving input of a voltage pulse of a spike signal generated by firing of the pre-neuron 6. The transistor M2 connected to the output of the latch 36 is arranged between the synapse circuit part 5 and the transistor M1, and connected to the transistor M1 in series. Therefore, when the output of the latch 36 is High level, the transistor M2 is opened so that the synapse current flows according to the spike signal input to the transistor M1. However, when the output of the latch 36 is Low level, the transistor M2 is closed. Thus, even when there is a spike signal input to the transistor M1, no synapse current flows since the transistor connected to the latch 36 is in an OFF-state.

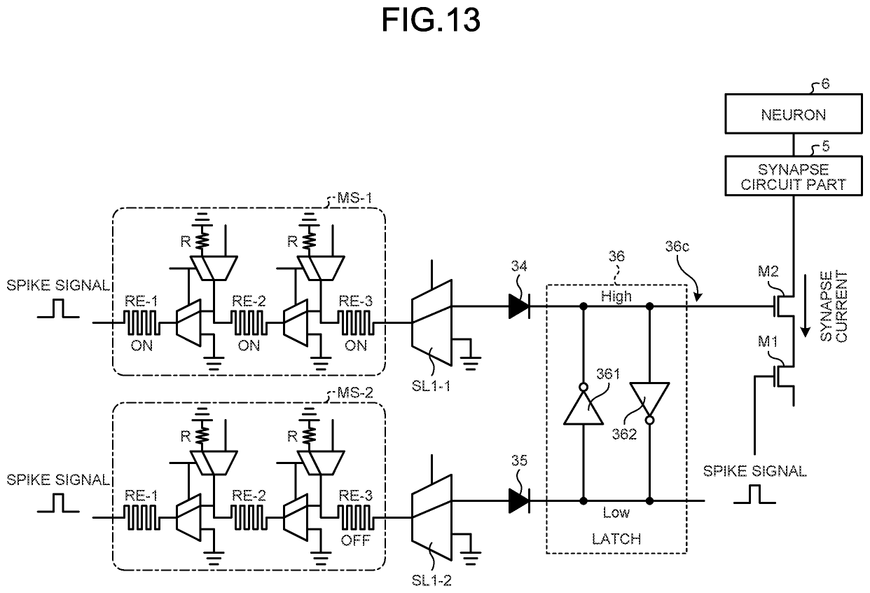

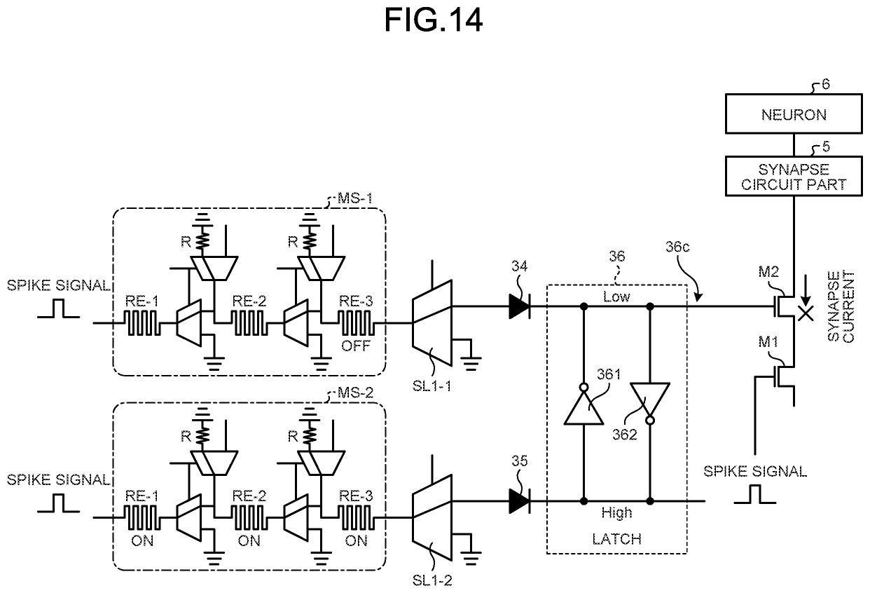

That is, a state where an output node 36c of the latch 36 is High level corresponds to a state with the weight w=1 where the input spike signal is converted to the synapse current as illustrated in FIG. 13, and a state where the output node 36c of the latch 36 is Low level corresponds to a state with the weight w=0 where the input spike signal is not converted to the synapse current as illustrated in FIG. 14, thereby implementing a binary synapse where the weight value takes “0” and “1”.

Note that the rectifier elements (for example, diodes) 34 and 35 are provided at the junctions between the series-connected switches MS-1, MS-2 and the latch 36 for rectifying the current to a direction from the series-connected switches MS-1, MS-2 toward the latch 36. This makes it possible to avoid the influence of the state of the latch 36 imposed upon the action of the series-connected switches MS-1 and MS-2.

In regards to the circuit of FIG. 12, connection at the time of inference is illustrated in FIG. 13 and FIG. 14. FIG. 13 illustrates a case where the upper series-connected switch MS-1 is ON (all of the resistance change elements RE are ON) and the lower series-connected switch MS-2 is OFF (any of the resistance change elements RE is OFF). Note here that when the pre-neuron fires, a spike signal is input with a voltage pulse not only to the transistor M1 but also to each of the upper series-connected switch MS-1 and the lower series-connected switch MS-2. The voltage pulse input to the upper series-connected switch MS-1 is input to the latch 36 via the resistance change element RE in an ON-state within the series-connected switch MS-1. In the meantime, the voltage pulse input to the lower series-connected switch MS-2 does not reach the latch 36 by being blocked on the way by the resistance change element RE in an OFF-state. Therefore, as for the latch 36 in FIG. 13, the upper side is High level and the lower side is Low level. That is, it is a state where the output node 36c of the latch 36 is High level, and the weight used for inference is w=1.

Meanwhile, in FIG. 14, the upper series-connected switch MS-1 is OFF and the lower series-connected switch MS-2 is ON. Note here that when the pre-neuron 6 fires, a spike signal is input with a voltage pulse not only to the transistor M1 but also to each of the upper series-connected switch MS-1 and the lower series-connected switch MS-2. The voltage pulse input to the lower series-connected switch MS-2 is input to the latch 36 via the resistance change element RE in an ON-state within the series-connected switch MS-2. In the meantime, the voltage pulse input to the upper series-connected switch MS-1 does not reach the latch 36 by being blocked on the way by the resistance change element RE in an OFF-state. Therefore, as for the latch 36 in FIG. 14, the upper side is High level and the lower side is Low level. That is, it is a state where the output node 36c of the latch 36 is High level, and the weight used for inference is w=0.

As it is clear from the above description, when the state of the latch 36 is set once in FIG. 13 and FIG. 14, the state of the latch 36 is maintained unless there is a change in the ON/OFF configuration of the resistance change elements RE. That is, there is no change in the weight w. In order to change the weight w, that is, in order to perform learning, it is necessary to change the ON/OFF configuration of the resistance change elements RE.

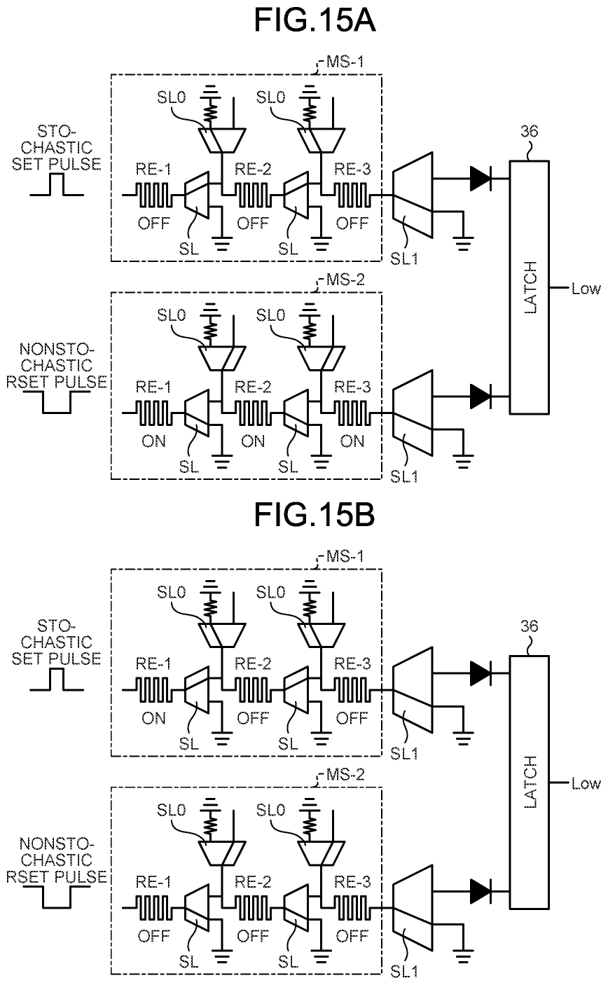

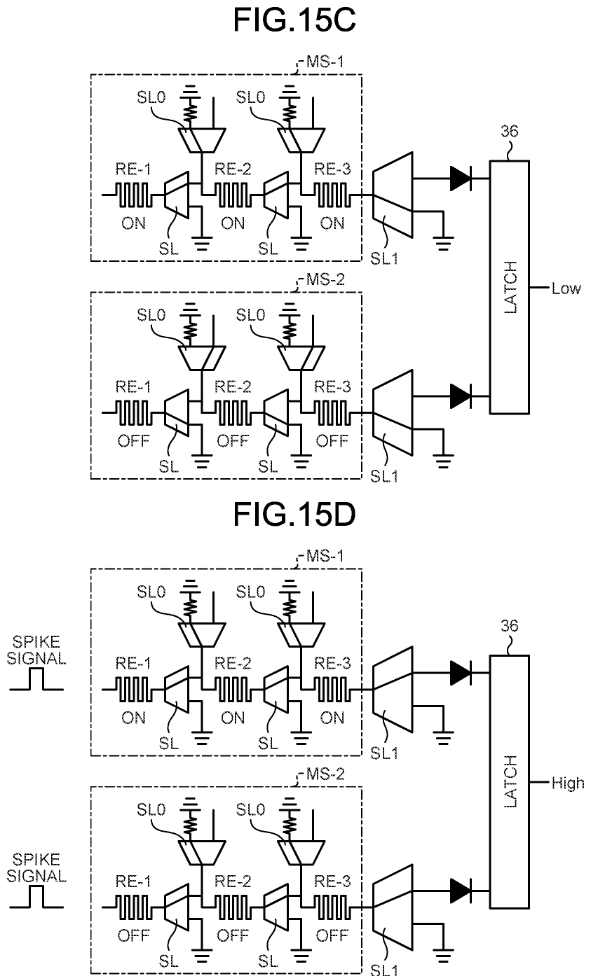

Learning will be described by using FIG. 15A to FIG. 15D. FIG. 15A illustrates a state of w=0 where the upper series-connected switch MS-1 is OFF, the lower series-connected switch MS-2 is ON, and the latch 36 outputs Low level. FIG. 15D illustrates a state of w=1 where the configuration of the resistance change elements is changed such that the upper series-connected switch MS-1 is turned to ON, the lower series-connected switch MS-2 is turned to OFF, and the latch 36 outputs High level. A method will be described for changing the state of the weight w=0 illustrated in FIG. 15A to the state of the weight w=1 illustrated in FIG. 15D.

The selectors SL, SL0, and SL1 in the circuit are connected as illustrated in FIG. 15A. That is, one ends of the resistance change elements RE-1, RE-2 of the upper series-connected switch MS-1 are grounded via the resistance R, and one end of the resistance change element RE-3 is grounded without being connected to the latch 36. One ends of the resistance change elements RE-1 and RE-2 of the lower series-connected switch MS-2 are not connected but connected to a voltage source to be able to perform a RESET action. A stochastic SET pulse is applied to the resistance change element RE-1 of the upper series-connected switch MS-1 (OFF-state). At the same time, a nonstochastic RESET voltage for stochastically changing the state to OFF is applied to each of the resistance change elements RE-1 to RE-3 of the lower series-connected switch MS-1 (ON-state). It is easy to stochastically turn OFF (RESET) the resistance change elements RE by appropriately designing the magnitude of the voltage and application time.

By repeating a series of such actions, the resistance change element RE-1 of the upper series-connected switch MS-1 is stochastically changed to an ON-state (FIG. 15B). While the resistance change elements RE-1 to RE-3 of the lower series-connected switch MS-2 are stochastically changed to OFF by a single action, the resistance change elements RE-1 to RE-3 in an OFF-state do not change any more even the RESET voltage is applied repeatedly. By repeating it further, all of the resistance change elements RE-1 to RE-3 of the upper series-connected switch MS-1 are changed to an ON-state (FIG. 15C). Now, when the selector SL1 is switched to start inference as illustrated in FIG. 15D, the latch 36 changes from Low level to High level according to the theory described above, thereby implementing a state of the synaptic weight w=1. Even in an intermediate state as in FIG. 15B, the latch 36 maintains the Low-level state, so that it is possible to perform inference by inputting spike to the transistor M1 (see FIG. 12) while being kept under the state of FIG. 15B. In this case, the upper series-connected switch MS-1 and the lower series-connected switch MS-2 both include the resistance change element RE in an OFF-state, so that an inference voltage pulse does not reach the latch 36. Therefore, the latch 36 is maintained in the Low-level state, and inference is performed with w=0.

In almost the same manner, it is also possible to change a state of w=1 where the upper series-connected switch MS-1 is ON, the lower series-connected switch MS-2 is OFF, and the latch 36 outputs High level to a state of w=0 where the upper series-connected switch MS-1 is OFF, the lower series-connected switch MS-2 is ON, and the latch 36 outputs Low level by changing the configuration of the resistance change elements RE. The description thereof will be omitted.

As described above, in the embodiment, the neural network device 1 having the binary synaptic weight uses the stochastic action part 31 where the cumulative probability of synapse transition exhibits a behavior of a sigmoidal function. For example, the stochastic action part 31 includes a plurality of stochastic switching elements connected in series, and the cumulative probability of the actions thereof changes in a sigmoidal shape with respect to the number of signal input times. This makes it possible to moderate the rise of transition of the weight with respect to the number of signal input times and protect the existing memory, so that the memory retaining property of the content learned by the stochastic STDP learning may be improved. Therefore, efficiency of the stochastic STDP learning may be improved. For example, the character recognition rate of the MNIST handwritten characters may be improved with the sigmoidal function stochastic STDP learning compared to the exponential-function stochastic STDP learning.

Note that the switching element is not limited to the binary element but may be any element that has a plurality of discrete states, and the state thereof stochastically transitions among the discrete states according to input of signals. The switching element may be a multi-level element where the state stochastically changes step by step among three or more states according to input of signals.

### Second Embodiment

Next, a neural network device according to a second embodiment will be described. Hereinafter the points different from those of the first embodiment will mainly be described.

In the first embodiment, sigmoidal function stochastic actions are implemented by the series-connected switch in which the stochastic switches are connected in series. In the second embodiment, however, sigmoidal function stochastic actions are implemented by a stochastic counter that counts a prescribed value stochastically generated from a random number generator.

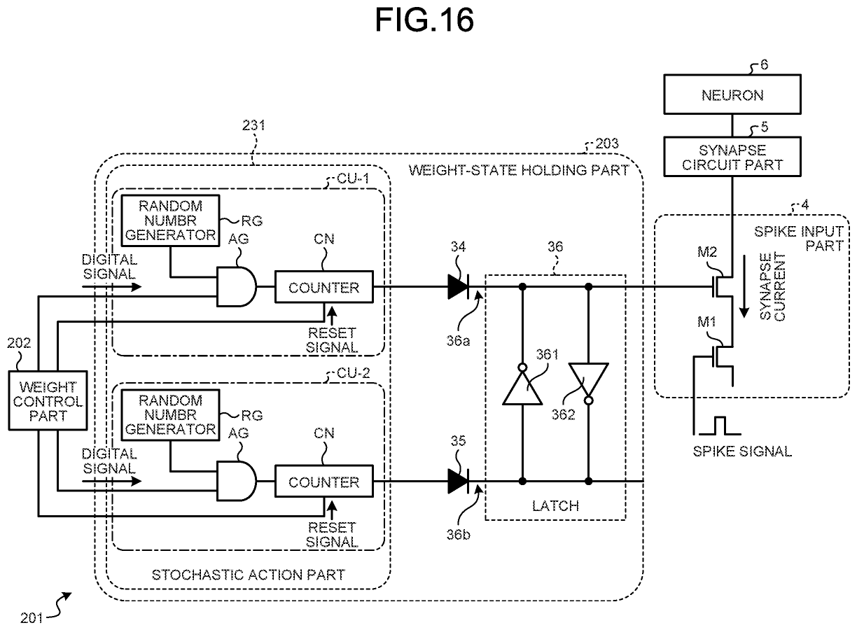

A neural network device 201 illustrated in FIG. 16 includes a weight control part 202 and a weight-state holding part 203 instead of the weight control part 2 and the weight-state holding part 3. The weight-state holding part 203 includes a stochastic action part 231 instead of the stochastic action part 31, but does not include the selectors SL1-1 and SL1-2.

The stochastic action part 231 includes a plurality of stochastic counters CU-1 and CU-2. The stochastic counters CU-1 and CU-2 are arranged in parallel between the weight control part 202 and the latch 36. Between the weight control part 202 and the latch 36, a series connection of the stochastic counter CU-1 and the rectifier element 34 and a series connection of the stochastic counter CU-2 and the rectifier element 35 are connected in parallel. Each of the stochastic counters CU-1 and CU-2 includes a random number generator RG, an AND circuit AG, and a counter CN. As for the AND circuit AG, a first input node is connected to the random number generator RG, a second input node is connected to the weight control part 202, and an output node is connected to the counter CN. As for the counter CN, a data input node is connected to the AND circuit AG, a reset input node is connected to the weight control part 202, and an output node is connected to the rectifier element 34 or 35.

For the neural network device 201, two parallel connections of upper and lower stochastic counters CU are prepared. As for each of the upper stochastic counter CU-1 and the lower stochastic counter CU-2, a digital signal from the weight control part 202 and a digital signal from the random number generator RG are input to the counter CN via the AND circuit AG. The output of the upper stochastic counter CU-1 is connected to an upper input node 36a of the latch 36, and the output of the lower stochastic counter CU-2 is connected to a lower input node 36b of the latch 36. The counter CN can receive a reset signal from the weight control part 202 at the reset input node.

A case of facilitating the synaptic weight w=0 to w=1 will be discussed. Since the weight is w=0 initially, the output of the latch 36 is Low level. When a digital signal is input to the upper stochastic counter CU-1 from the weight control part 202, a reset signal is input to the lower stochastic counter CU-2 at the same time. The AND circuit AG in the upper stochastic counter CU-1 outputs High level when the digital signal from the weight control part 202 and a random signal from the random number generator RG are both High level, and outputs Low level in other cases. By appropriately setting the random number generator RG, the probability for the AND circuit AG to output High level when the digital signal from the weight control part 202 is input can be set to an arbitrary value. The probability herein is defined as “p”.

When reset is released, the counter CN comes to a state capable of performing a count action, and holds the count value until the next reset. When the AND circuit AG outputs High level, the count value of the counter CN is incremented by one. That is, when the digital signal is input from the weight control part 202, the count value of the counter CN is incremented by one with the probability p. The counter CN, when it is reset, returns the count value to the initial value.

The counter CN outputs Low level (or 0) until the count value reaches a prescribed value k set in advance. The counter CN outputs High level (or 1) when the count value reaches the prescribed value k set in advance. When a High-level digital signal is input to the latch 36 from the counter CN, the state of the latch 36 changes. In this case, High level is output from the upper stochastic counter CU-1, so that the upper side of the latch 36 turns to High level and the lower side turns to Low level, and High level is output from the latch 36. Upon that, the M2 transistor is opened so that a synapse current can flow to the spike input part 4. This is a state of w=1. This is almost the same for a case where the synaptic weight w changes from w=1 to 0.

The probability that the count value of the counter CN reaches k for the number N of input times of the digital signal from the weight control part 202 can be expressed by Formula 12 or Formula 13. That is, the number N of input times of the digital signal from the weight control part 202 with which the count value of the counter CN reaches k follows a gamma distribution, so that the cumulative probability thereof forms a sigmoidal function as in FIG. 10. Therefore, the embodiment can be implemented by the circuit illustrated in FIG. 16.

As described above, with the neural network device 201 according to the second embodiment, a sigmoidal function stochastic action is implemented by the stochastic counter CU that counts the prescribed value stochastically generated from the random number generator RG. For example, the stochastic action part 231 includes the stochastic counter CU, and the cumulative probability of the action thereof changes in a sigmoidal shape for the number of signal input times. This makes it possible to moderate the rise of transition of the weight and protect the existing memory, so that the memory retaining property of the content learned by the stochastic STDP learning may be improved.

### Third Embodiment

Next, a neural network device according to a third embodiment will be described. Hereinafter the points different from those of the first embodiment and the second embodiment will mainly be described.

While the gamma distribution is used in the first embodiment and the second embodiment as a means for implementing a sigmoidal function, the distribution is not limited to the gamma distribution as long as the sigmoidal function may be implemented therewith. As an example thereof other than the gamma distribution, it is possible to use a Weibull distribution. With the Weibull distribution, the cumulative probability F that an event may occur for the number N of trials can be expressed as follows.

$$F ( N ) = 1 - exp [ - {( \frac{N}{{N}_{0}} )}^{β} ] \qquad Formula 14$$

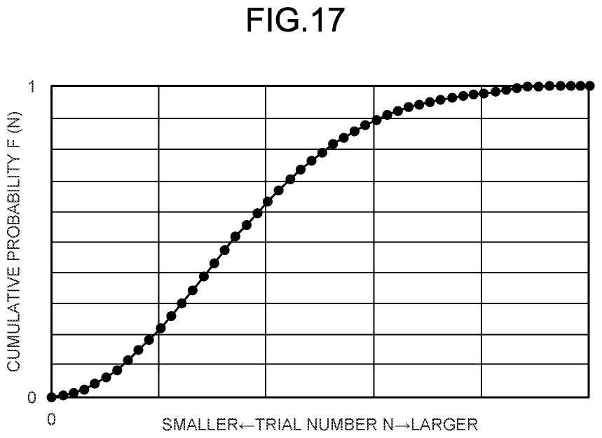

An example of a case where β=2 is illustrated in FIG. 17. It may be seen that the cumulative probability F(N) forms an sigmoidal function with respect to “N”. It has been discussed herein that the SET probability of the resistance change element that takes two states of LRS and HRS follows an exponential distribution. However, in a case of the resistance change element formed with a tantalum oxide, for example, it is known to follow the Weibull distribution with β=2 by setting the voltage.

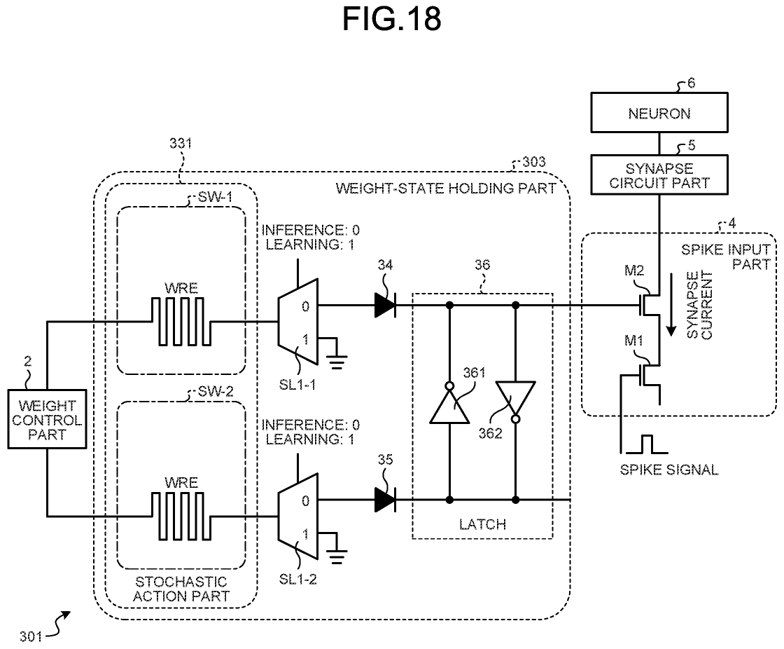

Thus, as illustrated in FIG. 18, it is possible to configure a neural network device 301 of the embodiment by using a resistance change element (Weibull resistance change element) WRE that follows the Weibull distribution with β=2. The neural network device 301 includes a weight-state holding part 303 instead of the weight-state holding part 3 (see FIG. 12). The weight-state holding part 303 includes a stochastic action part 331 instead of the stochastic action part 31 (see FIG. 12). The stochastic action part 331 includes a plurality of switches SW-1 and SW-2. The switches SW-1 and SW-2 are provided in parallel between the weight control part 2 and the latch 36. Between the weight control part 2 and the latch 36, a series connection of the switch SW-1, the selector SL1-1, and the rectifier element 34 and a series connection of the switch SW-2, the selector SL1-2, and the rectifier element 35 are connected in parallel. Each of the switches SW-1 and SW-2 includes the Weibull resistance change element WRE. It is similar to the first embodiment in respect that the rectifier elements (for example, diodes) 34 and 35 may better be provided between the Weibull resistance change element WRE and the latch 36 to avoid the influence of the state of the latch 36 imposed upon the action of the Weibull resistance change element WRE.

While FIG. 18 illustrates a case where the Weibull resistance change element WRE changes according to the Weibull distribution with β=2, the same effect may also be acquired by configuring the Weibull resistance change element WRE to change according to the Weibull distribution with any value of β satisfying β>1.

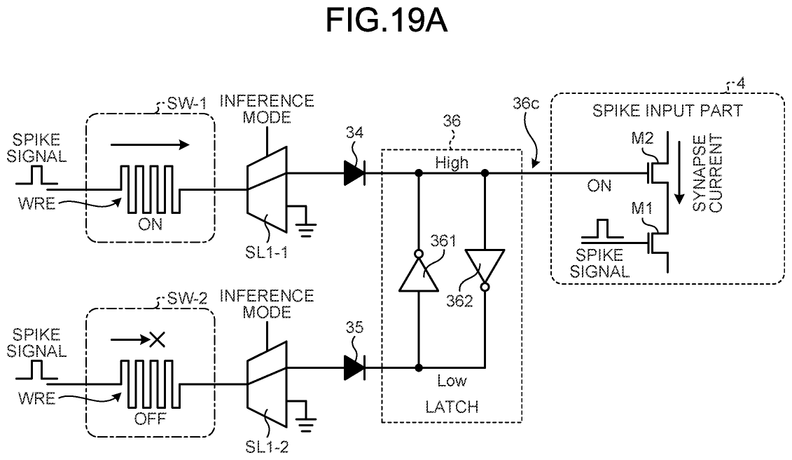

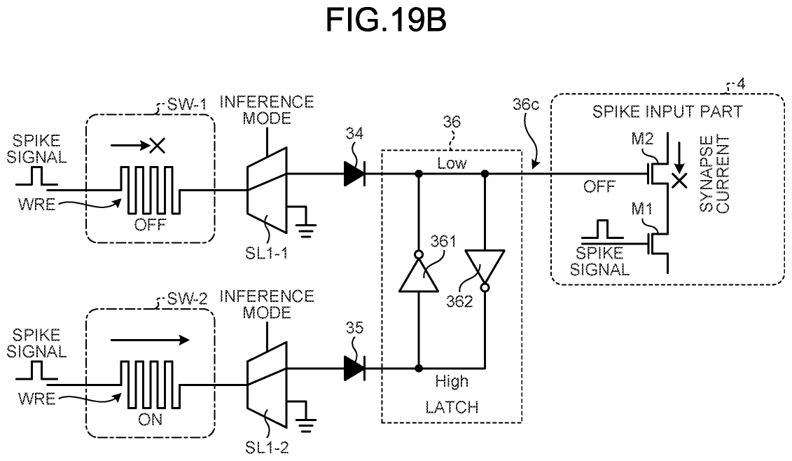

FIG. 19A and FIG. 199 illustrate the actions at the time of inference. In a state with the weight w=1 as illustrated in FIG. 19A, the Weibull resistance change element WRE of the upper switch SW-1 is in an ON-state (LRS), and the Weibull resistance change element WRE of the lower switch SW-2 is in an OFF-state (HRS). Simultaneously with the input of a spike signal to the spike input part 4, the spike signal is input with a voltage pulse to each of the Weibull resistance change element WRE of the upper switch SW-1 and the Weibull resistance change element WRE of the lower switch SW-2. The Weibull resistance change element WRE of the lower switch SW-2 is in an OFF-state, so that the voltage pulse is blocked. However, the Weibull resistance change element WRE of the upper switch SW-1 is in an ON-state, so that the voltage pulse passes the Weibull resistance change element WRE and reaches the latch 36. Thereby, the upper side of the latch 36 turns to a High-level state, and the lower side turns to a Low-level state. That is, the output node 36c of the latch 36 is High level, so that the transistor M2 is set ON, thereby allowing the synapse current to flow.

In a state with the weight w=0 as illustrated in FIG. 19B, the Weibull resistance change element WRE of the upper switch SW-1 is in an OFF-state (HRS), and the Weibull resistance change element WRE of the lower switch SW-2 is in an ON-state (LRS). Simultaneously with the input of a spike signal to the spike input part 4, the spike signal is input with a voltage pulse to each of the Weibull resistance change element WRE of the upper switch SW-1 and the Weibull resistance change element WRE of the lower switch SW-2. The Weibull resistance change element WRE of the upper switch SW-1 is an OFF-state, so that the voltage pulse is blocked. However, the Weibull resistance change element WRE of the lower switch SW-2 is in an ON-state, so that the voltage pulse passes the Weibull resistance change element WRE and reaches the latch 36. Thereby, the lower side of the latch 36 turns to a High-level state, and the upper side turns to a Low-level state. That is, the output node 36c of the latch 36 is Low level, so that the transistor M2 is set OFF, thereby not allowing the synapse current to flow.

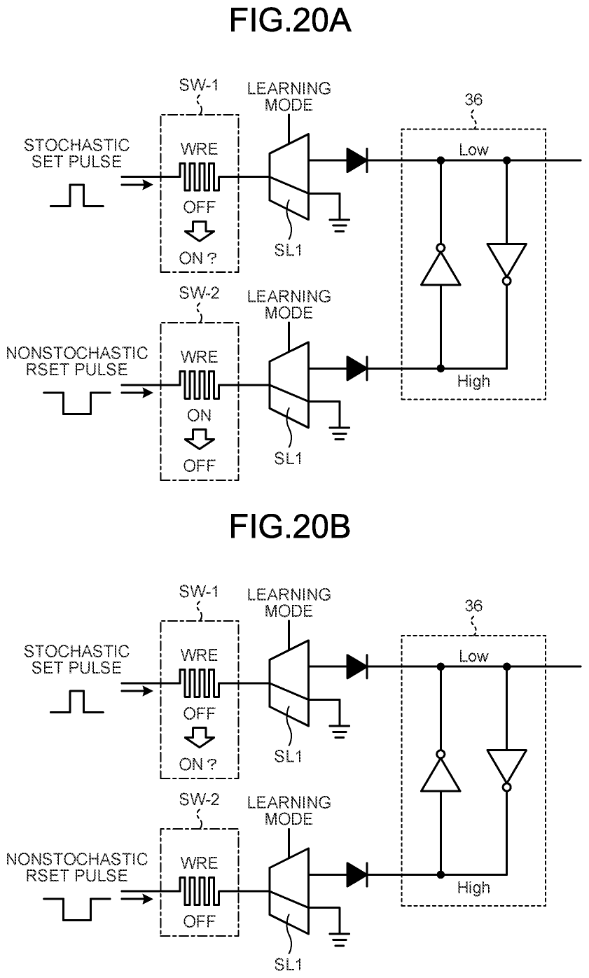

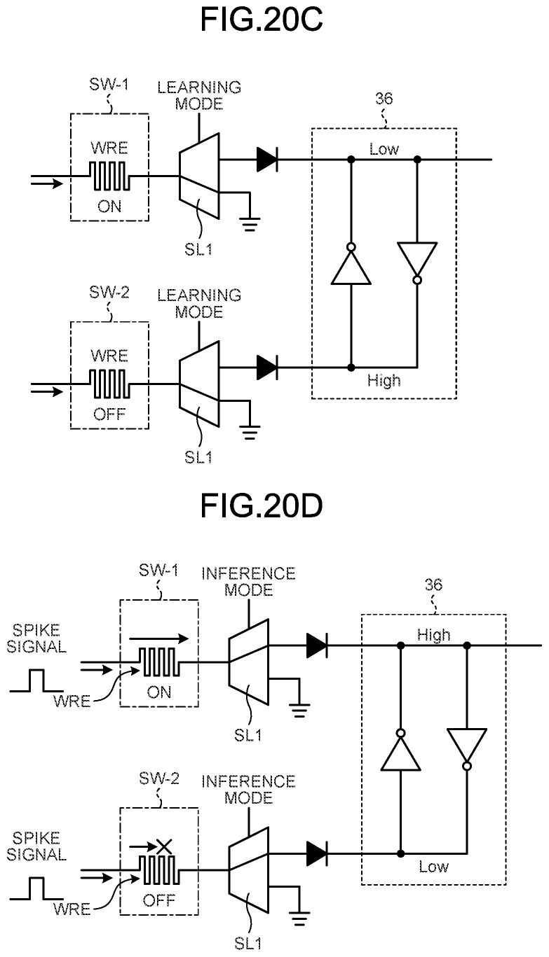

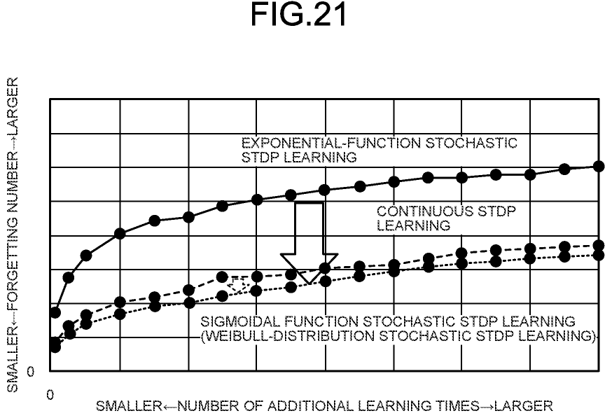

Learning will be described by using FIG. 20A to FIG. 20D. FIG. 20A illustrates a state of w=0 where the Weibull resistance change element WRE of the upper switch SW-1 is OFF, the Weibull resistance change element WRE of the lower switch SW-2 is ON, and the latch 36 outputs Low level. FIG. 20D illustrates a state of w=1 where the configuration of the Weibull resistance change elements WRE are changed such that the Weibull resistance change element WRE of the upper switch SW-1 is turned to ON, the Weibull resistance change element WRE of the lower switch SW-2 is turned to OFF, and the latch 36 outputs High level. A method will be described for changing the state of the weight w=0 illustrated in FIG. 20A to the state of the weight w=1 illustrated in FIG. 20D.

The selectors SL1 in the circuit are connected as illustrated in FIG. 20A. That is, one end of the Weibull resistance change element WRE of the upper switch SW-1 and one end of the Weibull resistance change element WRE of the lower switch SW-2 are grounded, respectively. The weight control part 2 applies a stochastic SET pulse to the Weibull resistance change element WRE (OFF-state) of the upper switch SW-1, and applies a nonstochastic RESET pulse to the Weibull resistance change element WRE (ON-state) of the lower switch SW-2. It is possible to stochastically RESET the Weibull resistance change elements WRE by appropriately setting the magnitude of the voltage amplitude and application time of the RESET pulse.

The Weibull resistance element WRE of the upper switch SW-1 stochastically operates, and therefore it does not necessarily change to an ON-state. However, by repeating such actions, the probability that the Weibull resistance element WRE of the upper switch SW-1 is in the ON-state is increased in a sigmoidal function form as illustrated in FIG. 20A to FIG. 20C. By repeating such actions, the RESET pulse is repeatedly applied to the Weibull resistance change element WRE of the lower switch SW-2. However, as illustrated in FIG. 20A to FIG. 20C, there is no more change occurred even when the RESET pulse is applied to the Weibull resistance change element WRE that is already in an OFF-state. In this manner, the Weibull resistance change element WRE of the upper switch SW-1 turns to an ON-state, and the Weibull resistance change element WRE of the lower switch SW-2 turns to an OFF-state at last as illustrated in FIG. 20C. Note here that as illustrated in FIG. 20D, when a spike signal for performing inference is applied with a voltage pulse to each of the upper switch SW-1 and the lower switch SW-2 by switching the selector SL1, the upper side of the latch 36 turns to High level and the lower side turns to Low level, and High level is output to the spike input part 4 from the latch 36 so that the synapse current can flow, thereby implementing a state with the weight w=1 (see FIG. 19A). In almost the same manner, it is also possible to change the state with the weight w=1 to the state with w=0. The detailed description thereof will be omitted.

FIG. 21 illustrates a case where additional learning is performed further after learning 10000 patterns of MNIST handwritten characters with stochastic STDP by using the Weibull resistance change element WRE. FIG. 21 illustrates, as a sigmoidal function stochastic STDP learning (Weibull-distribution stochastic DTDP learning), the number of neurons that lost the pattern stored at the point of 10000 times with respect to the number of additional learning times, plotted as forgetting numbers. The Weibull-distribution stochastic DTDP is an example of the sigmoidal function stochastic STDP.

With the sigmoidal function stochastic STDP according to the embodiment, for an arbitrary number of additional learning times, the forgetting number is greatly decreased with respect to the exponential-function stochastic STDP as indicated in FIG. 21 by a white arrow written with a solid line. In addition, as indicated in FIG. 21 by the white arrow written with a solid line, the sigmoidal function stochastic STDP according to the embodiment has an advantage with respect to the continuous STDP learning. With the sigmoidal function stochastic STDP learning according to the embodiment, the memory retaining property of the weight-state holding part 303 can be improved compared to the exponential-function stochastic STDP learning and the continuous STDP learning.

As described above, with the embodiment, the neural network device 301 having the binary synaptic weight uses the stochastic action part 331 where the cumulative probability of synapse transition exhibits a behavior of sigmoidal function. For example, the stochastic action part 331 includes the stochastic switching elements, and the cumulative probability of the actions thereof changes according to the Weibull distribution with β>1 with respect to the number of signal input times. This makes it possible to moderate the rise of transition of the weight with respect to the number of signal input times and protect the existing memory, so that the memory retaining property of the content learned by the stochastic STDP learning may be improved. Therefore, efficiency of the stochastic STDP learning may be improved. For example, the character recognition rate of the MNIST handwritten characters may be improved with the sigmoidal function stochastic STDP learning compared to the exponential-function stochastic STDP learning.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A neural network device comprising:
a neuron;
a conversion part that converts a spike signal to a synapse current according to weight;
a transmission part that transmits the converted synapse current to the neuron;
a control part that determines transition of a state of the weight; and
a holding part that holds the weight as a discrete state according to the determined transition of the state, wherein
the holding part includes an action part that stochastically operates based on a signal input from the control part to cause transition of the state of the weight, and
a cumulative probability of actions of the action part changes in a sigmoidal shape with respect to number of signal input times.

2. The neural network device according to claim 1, wherein
the cumulative probability of the actions of the action part changes curvaceously along a sigmoidal shape with respect to the number of signal input times.

3. The neural network device according to claim 1, wherein
the cumulative probability of the actions of the action part changes polylinearly along a sigmoidal shape with respect to the number of signal input times.

4. The neural network device according to claim 1, wherein
the cumulative probability of the actions of the action part changes according to a gamma distribution with respect to the number of signal input times.

5. The neural network device according to claim 1, wherein
the cumulative probability of the actions of the action part changes according to a Weibull distribution with respect to the number of signal input times.

6. The neural network device according to claim 1, wherein
the action part includes a plurality of switching elements connected in series, and
each of the switching elements has a plurality of discrete states, a state of the switching element stochastically transitioning among the discrete states according to the signal input.

7. The neural network device according to claim 1,
wherein
the action part includes:
a generator that generates a random number;
a counter; and
an arithmetic circuit that includes a first input node, a second input node and an output node, the first input node being a node to which the generator is
connected, the second input node being a node to receive an input signal, the output node being a node connected to the counter, the arithmetic circuit calculating a logical conjunction.

8. The neural network device according to claim 6, wherein
the switching element is a resistance change element having a plurality of discrete resistance states, a resistance state of the resistance change element stochastically transitioning among the discrete resistance states according to the signal input.

9. The neural network device according to claim 6, wherein
the switching element is a binary element, a state of the binary element stochastically changing from an OFF-state to an ON-state according to the input signal.

10. The neural network device according to claim 6, wherein
the switching element is a multi-level element, a state of the multi-level element stochastically changing among three or more states according to the input signal.

11. The neural network device according to claim 7, wherein
the counter outputs “0” until a count number reaches a prescribed value that is an integer of 2 or larger, and outputs “1” after the count number reaches the prescribed value.

12. A learning method used in a neural network device that comprises a neuron, a conversion part that converts a spike signal to a synapse current according to weight, a transmission part that transmits the converted synapse current to the neuron, and a holding part that holds the weight as a discrete state, the learning method comprising:
determining transition of a state of the weight;
stochastically causing transition of the state of the weight held in the holding part by inputting a signal to the holding part according to the determined transition of the state, wherein
a cumulative probability of the transition of the state of the weight in the changing changes in a sigmoidal shape with respect to number of signal input times.
